(19) United States
(12) Patent Application Publication
(10) Pub. No.: US 2008/0224528 A1
(43) Pub. Date: Sep. 18, 2008

(54) Method of welding brush filaments to a ferrule and resultant brush

(76) Inventor: Zhaohui Wang, Songjiang (CN)

Correspondence Address: TAFT, STETTINIUS & HOLLISTER LLP, SUITE 1800, 425 WALNUT STREET, CINCINNATI, OH, 45202-3957, US

(21) Appl. No.: 11/717,584

(22) Filed: Mar. 13, 2007

(51) Int. Cl. A46D 1/10; A46B 9/02; B23K 28/00; B23K 31/02

(52) U.S. Cl. 300/21; 15/160; 219/136; 219/137 R

(57) ABSTRACT

A method of welding brush filaments to a ferrule that includes the steps of providing a welding source that produces high frequency vibrations and/or heat, brush filaments, and a ferrule having an inner face, an outer face and an opening to receive the brush filaments, positioning the brush filaments at least partially into the opening of the ferrule, positioning the welding source proximate the outer face of the ferrule, and transferring the high frequency vibrations and/or heat from the welding source to one or more locations on the outer face of the ferrule.

### FIELD OF THE INVENTION

The present invention relates to a method of welding brush filaments to a ferrule and resultant brush. Specifically, the present invention relates to a method of sonic and/or heat welding brush filaments to a ferrule of a paint brush and the resultant paint brush. This includes utilizing high frequency vibrations and/or heat to fuse brush filaments to a ferrule.

### BACKGROUND OF THE INVENTION

Currently, a typical process of attaching filaments to a ferrule involves the use of expensive and difficult to handle epoxies or adhesives. For example, one current method of attaching filaments to a ferrule includes using a special pouring machine to pour a 2-part epoxy to bond the filaments and the ferrule, heating the epoxy in an oven, and waiting until the epoxy is cured. Curing times may exceed half an hour for some epoxies. Not only is this method time consuming, but purchasing the machinery and materials necessary to implement this method is expensive. Putting aside the cost of the machinery, the annual cost of epoxies can reach into the hundreds of thousands of dollars. To reduce these machinery and material costs and to shorten production time, it would be desirable to have a less expensive, less time consuming method.

There are known methods of connecting filaments to ferrules by welding. However, these methods involve welding filaments to a base manufactured from the same material as the filaments. Additionally, many toothbrushes, pastry brushes, and even some inexpensive paint brushes implement welding filaments directly to the base rather than to the ferrule itself. The present invention improves upon these known methods by utilizing sonic and/or heat welding to fuse filaments and ferrules of different materials.

### SUMMARY OF THE INVENTION

The present invention solves the above problems by providing a method of welding brush filaments to a ferrule and the resultant brush.

In a first embodiment of the present invention, the present invention is a method of welding brush filaments to a ferrule that includes the steps of: (a) providing a welding source that produces high frequency vibrations, brush filaments, and a ferrule having an inner face, an outer face and an opening to receive the brush filaments; (b) positioning the brush filaments at least partially into the opening of the ferrule; (c) positioning the welding source proximate the outer face of the ferrule; and (d) transferring the high frequency vibrations from the welding source to one or more locations on the outer face of the ferrule. The high frequency vibrations are then transferred from the outer face of the ferrule to the inner face of the ferrule, causing the brush filaments to bond with the inner face of the ferrule and each other. In another embodiment of the present invention, the high frequency vibrations are amplified prior to being transferred to the one or more locations on the outer face of the ferrule. In an exemplary embodiment, the high frequency vibrations occur in the 15 kHz to 40 kHz range. In an exemplary embodiment, the brush filaments consist of bristles for a paint brush. In this embodiment, the brush filaments may be manufactured from polyester, polyolefin, nylon 6/12, bristle, a polyester/nylon blend, a polyester/bristle blend, other plastic, or a combination thereof. Further, the ferrule may be manufactured from tin, brass, nickel, copper, steel, plastic, metal, or a combination thereof.

In a second embodiment of the present invention, the present invention is a method of welding a paint brush that includes the steps of providing paint brush filaments and a ferrule having an outer face and an inner face, positioning the paint brush filaments proximate the inner face of the ferrule, and directing high frequency vibrations at one or more locations on the outer face of the ferrule such that the high frequency vibrations are transferred to the inner face of the ferrule and the paint brush filaments. The high frequency vibrations cause the paint brush filaments to fuse to the inner face of the ferrule and each other. In this embodiment, the brush filaments may be manufactured from polyester, polyolefin, nylon 6/12, bristle, a polyester/nylon blend, a polyester/bristle blend, other plastic, or a combination thereof. Further, the ferrule may be manufactured from tin, brass, nickel, copper, steel, plastic, metal, or a combination thereof.

In a third embodiment of the present invention, the present invention is a method of welding a paint brush that includes the steps of providing paint brush components including brush filaments and a brush collar, inserting the brush filaments into the brush collar such that a portion of the brush filaments is not contained within the brush collar, applying high frequency vibrations to at least one location on the brush collar. The high frequency vibrations then cause the brush filaments to fuse with the brush collar and each other.

In a fourth embodiment of the present invention, the present invention is a paint brush having a handle, brush filaments for applying paint, a ferrule for coupling the handle to the brush filaments. In this embodiment, the ferrule is welded to the brush filaments using high frequency vibrations. The brush filaments may be manufactured from polyester, polyolefin, nylon 6/12, bristle, a polyester/nylon blend, a polyester/bristle blend, other plastic, or a combination thereof. Further, the ferrule may be manufactured from tin, brass, nickel, copper, steel, plastic, other metal, or a combination thereof.

In a fifth embodiment of the present invention, the present invention is a method of welding brush filaments to a ferrule that includes the steps of: (a) providing a welding source that produces heat, brush filaments, and a ferrule having an inner face, an outer face and an opening to receive the brush filaments; (b) positioning the brush filaments at least partially into the opening of the ferrule; (c) positioning the welding source proximate the outer face of the ferrule; and (d) transferring the heat from the welding source to one or more locations on the outer face of the ferrule. The heat is then transferred from the outer face of the ferrule to the inner face of the ferrule, causing the brush filaments to bond with the inner face of the ferrule and each other. In an exemplary embodiment, the welding source is a hot plate. In an exemplary embodiment, the brush filaments consist of bristles for a paint brush. In this embodiment, the brush filaments may be manufactured from polyester, polyolefin, nylon 6/12, bristle, a polyester/nylon blend, a polyester/bristle blend, other plastic, or a combination thereof. Further, the ferrule may be manufactured from tin, brass, nickel, copper, steel, plastic, metal, or a combination thereof.

In a sixth embodiment of the present invention, the present invention is a method of welding brush filaments to a ferrule that includes the steps of: (a) providing a welding source that produces high frequency vibrations and heat, brush filaments, and a ferrule having an inner face, an outer face and an opening to receive the brush filaments; (b) positioning the brush filaments at least partially into the opening of the ferrule; (c) positioning the welding source proximate the outer face of the ferrule; and (d) transferring the high frequency vibrations and heat from the welding source to one or more locations on the outer face of the ferrule. The high frequency vibrations and heat are then transferred from the outer face of the ferrule to the inner face of the ferrule, causing the brush filaments to bond with the inner face of the ferrule and each other. In an exemplary embodiment, the brush filaments consist of bristles for a paint brush. In this embodiment, the brush filaments may be manufactured from polyester, polyolefin, nylon 6/12, bristle, a polyester/nylon blend, a polyester/bristle blend, other plastic, or a combination thereof. Further, the ferrule may be manufactured from tin, brass, nickel, copper, steel, plastic, metal, or a combination thereof.

From the foregoing disclosure and the following detailed description of various preferred embodiments it will be apparent to those skilled in the art that the present invention provides a significant advance in the art of welding brush filaments and ferrules. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a flow diagram depicting an exemplary embodiment of the present invention.

FIG. 2 is a side view of components utilized in various embodiments of the present invention.

### DETAILED DESCRIPTION OF THE DRAWINGS

It will be apparent to those skilled in the art that many uses and variations are possible for the method of welding brush filaments to a ferrule and resultant brush disclosed herein. The following detailed discussion of various alternative and preferred embodiments will illustrate the general principles of the invention. Other embodiments will be apparent to those skilled in the art given the benefit of this disclosure.

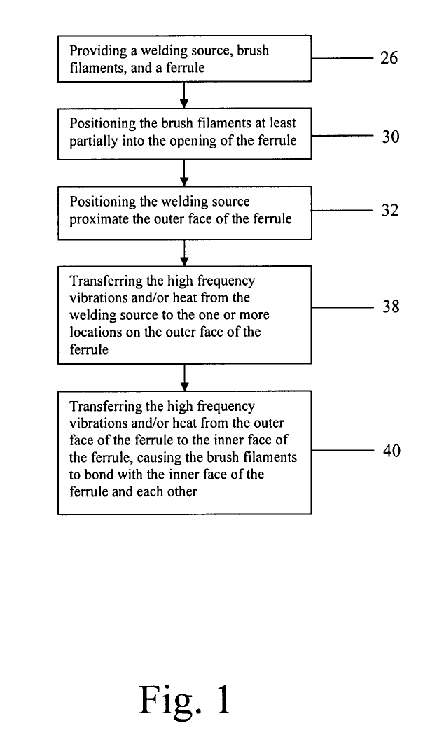

FIG. 1 depicts a flow diagram depicting an exemplary embodiment of the present invention. In this exemplary embodiment, a welding source 20, brush filaments 22, and a ferrule 24 are provided 26. In this exemplary embodiment, the ferrule 24 has an outer face 28 and an opening to receive the brush filaments 22. The brush filaments 22 are then positioned 30 such that at least part of the brush filaments 22 is inside the opening of the ferrule 24. The welding source 20 is positioned 32 such that it is proximate or near the outer face 28 of the ferrule 24. In another embodiment, the step of positioning 32 the welding source 20 near the outer face 28 of the ferrule 24 may occur before the step of positioning 30 the brush filaments 22 at least partially inside the opening of the ferrule 24. High frequency vibrations and/or heat are transferred 38 from the welding source 20 to the outer face 28 of the ferrule 24 at one or more locations on the outer face 28 of the ferrule 24. Subsequently, the high frequency vibrations and/or heat are transferred 40 from the outer face 28 of the ferrule 24 to the inner face of the ferrule 24. These high frequency vibrations and/or heat then cause the brush filaments 22 to bond or fuse with the inner face of the ferrule 24 and each other.

In another embodiment, the high frequency vibrations may be amplified prior to being transferred 38 to the outer face 28 of the ferrule 24. This amplification step may occur in the welding source 20 itself, through a machine accessory, or by third party means. In an exemplary embodiment, the high frequency vibrations have a frequency in the range of 15 kHz to 40 kHz. For example, a machine manufactured by Branson Ultrasonics Corporation produces vibrations with frequencies of 15 kHz, 20 kHz, 30 kHz, or 40 kHz. Any of these frequencies would be sufficient for the present invention. Any other frequencies in or near the 15 kHz to 40 kHz range would also be sufficient.

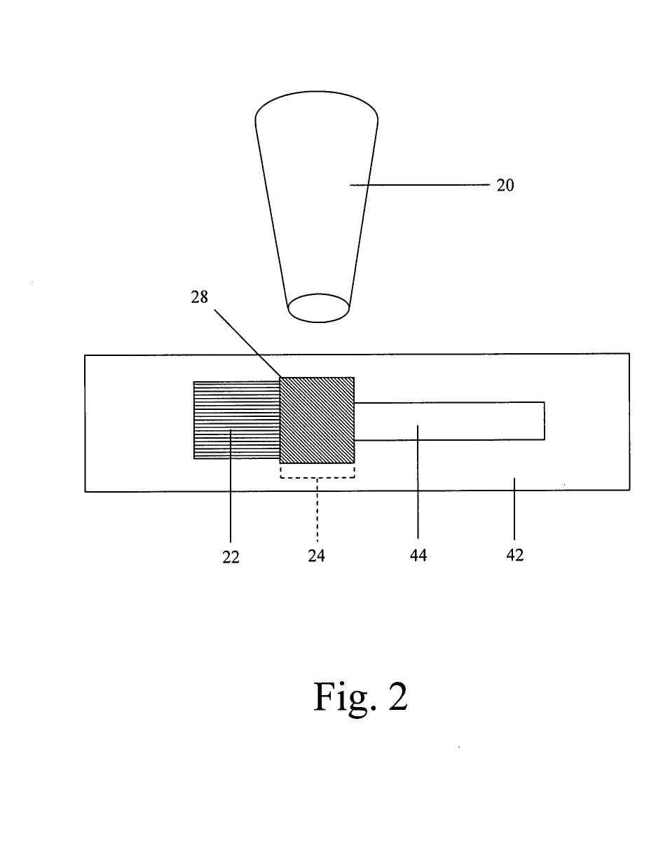

FIG. 2 depicts an exemplary setup of the components utilized in the present invention. In this embodiment, the brush filaments 22 and the ferrule 24 are positioned 30 such that at least a portion of the brush filaments 22 is located inside the ferrule 24 opening and a portion of the brush filaments 22 is located outside the ferrule 24 opening. This Figure shows a portion of the brush filaments 22 located outside the ferrule 24 opening. The portion of brush filaments 22 located inside the ferrule 24 opening is not visible in this Figure. In an exemplary embodiment, the ferrule 24 and the brush filaments 22 are positioned 30 such that they are coplanar in a plane parallel to the floor. The ferrule 24 and brush filaments 22 may be positioned 30 on a fixed surface 42 or on a moveable surface 42 such as a conveyor belt. A conveyor belt or other moveable surface 42 may be utilized for fast-paced, high quantity production. The welding source 20 may be positioned 32 in a plane that is perpendicular to the floor. The welding source 20 may also be positioned 32 on a fixed or moveable surface. Other position arrangements may also be implemented depending on a user's needs.

The welding source 20 may be a sonic welding machine 20, a heat welding machine 20, or any other welding source 20 capable of producing high frequency vibrations and/or heat. As discussed above, an example of such a machine is manufactured by Branson Ultrasonics Corporation. However, any other machine that produces high frequency vibrations with frequencies in the disclosed range may also be implemented in the method of the present invention. Any machine that produces heat may also be used in other embodiments. In an exemplary embodiment, the welding source 20 incorporates a hot plate member to uniformly apply heat.

Brush filaments 22 may include a plurality of filaments 22 such as bristles or a singular filament 22 such as the filament from a foam brush. Further, brush filaments 22 may be manufactured from polyester, polyolefin, nylon 6/12, bristle, a polyester/nylon blend, a polyester/bristle blend, other plastic, a combination thereof, or any other similar material known in the art.

The ferrule 24 is typically a collar for connecting a brush handle 44 to brush filaments 22. The ferrule 24 may be manufactured from tin, brass, nickel, copper, steel, plastic, a combination thereof, or any other metal or plastic known in the art. In an exemplary embodiment, the welding method is applied to fuse polyester brush filaments 22 and a nickel ferrule 24. However, any other combination of brush filaments 22 and ferrule 24 materials may be fused by implementing the method of the present invention.

The paint brush created by various embodiments of the invention may have a handle 44, brush filaments 22 for applying paint, a ferrule 24 for coupling the handle 44 to the brush filaments 22. The ferrule 24 is welded to the brush filaments 22 using high frequency vibrations and/or heat.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

It will be appreciated by persons skilled in the art that the present invention is not limited to what has been particularly shown and described in herein. The scope of the present invention is defined only by the claims which follow.

What is claimed is:

1. A method of welding brush filaments to a ferrule, the method comprising the steps of:
providing a welding source that produces high frequency vibrations, brush filaments, and a ferrule having an inner face, an outer face, and an opening to receive the brush filaments;
positioning the brush filaments at least partially into the opening of the ferrule;
positioning the welding source proximate the outer face of the ferrule; and
transferring the high frequency vibrations from the welding source to one or more locations on the outer face of the ferrule;
whereby the high frequency vibrations are transferred from the outer face of the ferrule to the inner face of the ferrule, causing the brush filaments to bond with the inner face of the ferrule and each other.

2. The method of welding brush filaments to a ferrule of claim 1, further comprising the step of:
amplifying the high frequency vibrations prior to being transferred to the one or more locations on the outer face of the ferrule.

3. The method of welding brush filaments to a ferrule of claim 1, wherein the high frequency vibrations have a frequency in the range of 15 kHz to 40 kHz.

4. The method of welding brush filaments to a ferrule of claim 1, wherein the brush filaments consist of bristles for a paint brush.

5. The method of welding brush filaments to a ferrule of claim 1, wherein the brush filaments are manufactured from polyester, polyolefin, nylon 6/12, bristle, a polyester/nylon blend, a polyester/bristle blend, other plastic, or a combination thereof.

6. The method of welding brush filaments to a ferrule of claim 1, wherein the ferrule is manufactured from tin, brass, nickel, copper, steel, plastic, other metal, or a combination thereof.

7. A method of welding a paint brush, the method comprising the steps of:
providing paint brush filaments and a ferrule having an outer face and an inner face;
positioning the paint brush filaments proximate the inner face of the ferrule; and
directing high frequency vibrations at one or more locations on the outer face of the ferrule such that the high frequency vibrations are transferred to the inner face of the ferrule and the paint brush filaments;
whereby the high frequency vibrations cause the paint brush filaments to fuse with the inner face of the ferrule and each other.

8. The method of welding a paint brush of claim 7, wherein the paint brush filaments are manufactured from polyester, polyolefin, nylon 6/12, bristle, a polyester/nylon blend, a polyester/bristle blend, other plastic, or a combination thereof.

9 The method of welding a paint brush of claim 7, wherein the ferrule is manufactured from tin, brass, nickel, copper, steel, plastic, other metal, or a combination thereof.

10. A method of welding a paint brush, comprising the steps of:
providing paint brush components including brush filaments and a brush collar;
inserting the brush filaments into the brush collar such that a portion of the brush filaments is not contained within the brush collar;
applying high frequency vibrations to at least one location on the brush collar;
whereby the high frequency vibrations cause the brush filaments to fuse with the brush collar and each other.

11. A paint brush comprising:
a handle;
brush filaments for applying paint;
a ferrule for coupling the handle to the brush filaments;
wherein the ferrule is welded to the brush filaments using high frequency vibrations.

12. The paint brush of claim 11, wherein the brush filaments are manufactured from polyester, polyolefin, nylon 6/12, bristle, a polyester/nylon blend, a polyester/bristle blend, other plastic, or a combination thereof.

13 The paint brush of claim 11, wherein the ferrule is manufactured from tin, brass, nickel, copper, steel, plastic, other metal, or a combination thereof.

14. A method of welding brush filaments to a ferrule, the method comprising the steps of:
providing a welding source that produces heat, brush filaments, and a ferrule having an inner face, an outer face, and an opening to receive the brush filaments;
positioning the brush filaments at least partially into the opening of the ferrule;
positioning the welding source proximate the outer face of the ferrule; and
transferring the heat from the welding source to one or more locations on the outer face of the ferrule;
whereby the heat is transferred from the outer face of the ferrule to the inner face of the ferrule, causing the brush filaments to bond with the inner face of the ferrule and each other.

15. The method of welding brush filaments to a ferrule of claim 14, wherein the welding source is a hot plate.

16. The method of welding brush filaments to a ferrule of claim 14, wherein the brush filaments consist of bristles for a paint brush.

17. The method of welding brush filaments to a ferrule of claim 14, wherein the brush filaments are manufactured from polyester, polyolefin, nylon 6/12, bristle, a polyester/nylon blend, a polyester/bristle blend, other plastic, or a combination thereof.

18. The method of welding brush filaments to a ferrule of claim 14, wherein the ferrule is manufactured from tin, brass, nickel, copper, steel, plastic, other metal, or a combination thereof.

19. A method of welding brush filaments to a ferrule, the method comprising the steps of:
providing a welding source that produces high frequency vibrations and heat, brush filaments, and a ferrule having an inner face, an outer face, and an opening to receive the brush filaments;
positioning the brush filaments at least partially into the opening of the ferrule;
positioning the welding source proximate the outer face of the ferrule; and
transferring the high frequency vibrations and heat from the welding source to one or more locations on the outer face of the ferrule;
whereby the high frequency vibrations and heat are transferred from the outer face of the ferrule to the inner face of the ferrule, causing the brush filaments to bond with the inner face of the ferrule and each other.

20. The method of welding brush filaments to a ferrule of claim 19, wherein the brush filaments consist of bristles for a paint brush.

21. The method of welding brush filaments to a ferrule of claim 19, wherein the brush filaments are manufactured from polyester, polyolefin, nylon 6/12, bristle, a polyester/nylon blend, a polyester/bristle blend, other plastic, or a combination thereof.

22. The method of welding brush filaments to a ferrule of claim 19, wherein the ferrule is manufactured from tin, brass, nickel, copper, steel, plastic, other metal, or a combination thereof.
